(19) United States
(12) Patent Application Publication
(10) Pub. No.: US 2016/0267575 A1
(43) Pub. Date: Sep. 15, 2016

(54) System for Distributing Item Listing Notifications

(71) Applicant: TapNSell, Inc., San Francisco, CA (US)

(72) Inventors: Carlos Garcia, Lakewood Ranch, FL (US); Lupe Garcia, Lakewood Ranch, FL (US)

(21) Appl. No.: 15/019,443

(22) Filed: Feb. 9, 2016

Related U.S. Application Data
(60) Provisional application No. 62/113,661, filed on Feb. 9, 2015.

(51) Int. Cl. G06Q 30/06; H04L 12/58; H04L 29/08

(52) U.S. Cl. CPC G06Q 30/0643; H04L 67/26; H04L 67/22; H04L 67/10; H04L 51/24; H04L 67/306; G06Q 50/01

(57) ABSTRACT

A server device is configured to distribute a notification regarding an item listing. The server device includes a controller having a memory and a processor, the controller of the server device configured to receive from a first user device item listing information associated with an item and listing distribution information, generate a dynamic item listing based upon the received item listing information, and forward an item listing notification associated with the dynamic item listing to a second user device identified by the listing distribution information.

### RELATED APPLICATIONS

This patent application claims the benefit of U.S. Provisional Application No. 62/113,661, filed on Feb. 9, 2015, entitled, “System for Providing Content to a Network Commerce Site,” the contents and teachings of which are hereby incorporated by reference in their entirety.

### BACKGROUND

With the development of the Internet, users have been able to connect with each other in a variety of ways. For example, users can buy and sell goods in a number of forums or commerce sites, such as EBAY and Craigslist. To post an item for sale, the user typically first takes a digital photograph of the item via a digital camera and connects the camera to a computer in order to transfer those pictures from the camera. The user then uploads the photos to a commerce site, and associates a description and pricing information with the item using the commerce site's registration process.

### SUMMARY

Conventional online commerce systems suffer from a variety of deficiencies. For example, selling an item online can be time consuming even for the advanced Internet user. As indicated above, there are many steps to this process, such as the requirement to own a digital camera and the connection of the camera to a computer, which may involve installing software and drivers. Further, uploading photos and a description of an item for sale can be a complicated process. For example, conventional commerce sites such as EBAY and Craigslist each have long and complicated registration processes to become a seller and to list an item for sale.

By contrast to conventional online commerce techniques, embodiments of the present innovation relate to a system for distributing item listing notifications. In one arrangement, a user device, such as a mobile computerized device is configured to provide item listing information, such as a description and price of an item for sale, to a server device. The server device is configured to distribute a hyperlink for a dynamic item listing, such as a web page which includes the listing information, to a variety of receiver devices, such as network commerce sites, social media sites, or individual devices identified from a contacts list stored by the user device. In one arrangement, the mobile device is configured to retrieve product pricing information from one or more network commerce sites, such as via a scanning application. In one arrangement, the server device is configured to monitor the purchasing behavior of a first set of user devices within the system and can provide notifications to a second set of user devices based upon the monitored purchase behavior.

In one arrangement, embodiments of the innovation relate to a method for distributing a notification regarding an item listing in a server device. The method includes receiving from a first user device, by the server device, item listing information associated with an item and listing distribution information. The method includes generating, by the server device, a dynamic item listing based upon the received item listing information. The method includes forwarding, by the server device, an item listing notification associated with the dynamic item listing to a second user device identified by the listing distribution information.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of an item listing notification system, according to one arrangement.

FIG. 2 illustrates an example of a user device and display providing a contact list, according to one arrangement.

FIG. 3 illustrates a schematic representation of an item listing notification system, according to one arrangement.

FIG. 4 illustrates a schematic representation of an item listing notification system, having a user device configured to detect commerce behavior associated with a user, according to one arrangement.

FIG. 5 illustrates a screen image of a scanning application as executed by the user device, according to one arrangement.

### DETAILED DESCRIPTION

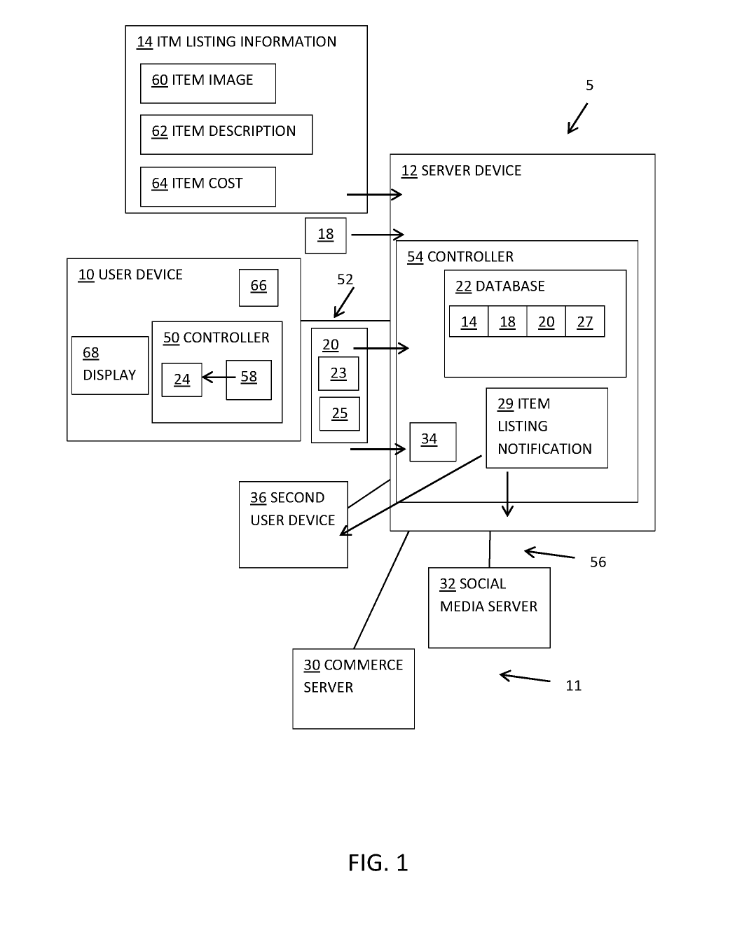

FIG. 1 illustrates an item listing notification system 5 configured to distribute item or product listing information between a user device 10 and one or more receiver devices 11, according to one arrangement.

As shown in FIG. 1, the listing notification system 5 includes a user device 10, such as a mobile phone (e.g., smartphone), a tablet device, a laptop computer, or other computerized device. The user device 10 includes a controller 50, such as a memory and a processor and is disposed in electrical communication with a server device 12, such as via a network 52. The network 52 can be configured as either a wired or wireless wide-area network (WAN) or local-area network (LAN). The controller 50 of the user device 10 is configured to execute an item listing application 58, a description of which is provided below.

The server device 12, such as a computerized device, includes a controller 54, such as a memory and a processor. In one arrangement, the server device 12 is disposed in electrical communication with a variety of receiver devices 11 via a network 56 such as a wired or wireless WAN or LAN. As will be described below, the server device 12 is configured to receive item listing information 14 from the user device 10 and provide a corresponding item listing notification 29 to one or more of the receiver devices 11. For example, the item listing information 14 can relate to a product or item that a user wants to sell within the listing notification system 5.

Each of the receiver devices 11 can be configured in a variety of ways. In one arrangement, a receiver device 11 can be configured as a commerce server device 30 (i.e., computerized device) associated with a given on-line commerce platform. For example, the commerce server device 30 can be configured with the EBAY commerce platform or with the AMAZON commerce platform. In one arrangement, a receiver device 11 can be configured as a social media server device 32 associated with particular on-line social media platforms. For example, social media server device 32 (i.e., computerized device) can be configured with the FACEBOOK social media platform or with the TWITTER social media platform.

As indicated above, the server device 12 is configured to distribute item listing notifications 29 for an item or product listing between the user device 10 and the receiver devices 11. The following provides a description of an example of the operation of the server device 12 when providing such distribution.

In use, the server device 12 is configured to receive item listing information 14 associated with an item, as well as listing distribution information 20, from the user device 10 (i.e., the first user device).

For example, assume the case where a user of the user device 10 wants to list a softball for sale in the listing notification system 5. In such a case, the user activates the listing application 58 associated with the user device 10 which causes the user device 10 to request the user to provide item listing information 14 associated with the softball. For example, the listing application 58 can request that the user provide one or more item images 60 associated with the softball, an item description 62, such as a title, item category tag, and/or description of the softball, and an item cost 64 or price associated with the softball. In one arrangement, the user device 10 allows the user to preview the item listing information 14 via a display 68 to confirm correctness of the item listing information 14 before transmitting the information 14 to the server device 12.

The listing application 58 can configure the user device 10 to obtain the item image 60 in a variety of ways. For example, the listing application 58 can configure the user device 10 to access a camera 66 associated with the user device 10 such that the user device 10 can generate a number of photographs and/or a video of a product or item for sale, such as the softball. In another example, the listing application 58 can configure the user device 10 to access a set of images stored by the controller (e.g., memory) of the user device 10, such as images of the softball.

As indicated above, the user device 10 is also configured to provide listing distribution information 20 to the item server device 12. In one arrangement, the user device 10 executing the listing application 58 can request that the user select a particular social media or commerce platform for distribution of the item listing information 14. Based upon the user selection, the user device 10 stores the user selection as listing distribution information 20, which identifies the social media or commerce platform which will receive notification regarding the item listing information 14. For example, the listing distribution information 20 can be configured as, or can include, a commerce identifier 23 which relates to a particular commerce platform (e.g., the EBAY commerce platform, the AMAZON commerce platform, etc.). Further, the listing distribution information 20 can be configured as, or can include, a social media identifier 25 which relates to a particular social media platform (e.g., the FACEBOOK social media platform, the TWITTER social media platform, etc.).

When the user directs the user device 10, via the listing application 58, to post the item listing information 14, the user device 10 transmits the item listing information 14, the listing distribution information 20, and a user device identifier 18 (e.g., a user account number associated with the server device 12) to the server device 12 via the network 52. When the server device 12 receives the item listing information 14, the sever device 12 can store the item listing information 14 and the listing distribution information 20 in a database 22 as part of the user account identified by the user device identifier 18.

Next, the server device 12 generates a dynamic item listing 27 based upon the received item listing information 14. For example, when the server device 12 receives an item image 60, an item description 62, and an item cost 64 as the item listing information 14, the server device 12 generates the dynamic item listing 27, such as a webpage, which includes the item image 60, the item description 62, and the item cost 64. In one arrangement, the server device 12 associates the dynamic item listing 27 with the user device identifier 18 and stores the dynamic item listing 27 in the database 22 as part of a user account.

The server device 12 then forwards an item listing notification 29 associated with the dynamic item listing 27 to a second user device, such as receiver device 11, identified by the listing distribution information 20. For example, in the case where the listing distribution information 20 is a commerce identifier 23, the server device 12 is configured to forward the item listing notification 29 associated with the dynamic item listing 27 to a commerce server 30 associated with the commerce identifier 23. Further, in the case where the listing distribution information 20 is a social media identifier 25, the server device 12 is configured to forward the item listing notification 29 associated with the dynamic item listing 27 to a social media server 32 associated with the social media identifier 25.

The item listing notification 29 can be configured in a variety of ways. In one arrangement, the server device 12 generates the item listing notification 29 as a message which includes a hypertext link to the corresponding dynamic item listing 27 stored by the server device 12. In such a case, when an end user device in communication with the social media platform or commerce platform activates the hypertext link, as provided by the platform, the end user device is directed to the associated dynamic item listing 27 stored by the server device 12.

In one arrangement, the server device 12 is configured to format the item listing notification 29 into a form that is compatible with the commerce or social media platforms. For example, the item server device 12 utilizes the listing distribution information 20 to generate a formatted item listing notification 29 which corresponds to the destination identified in the listing distribution information 20. For example, assume the user device 10 indicates in the listing distribution information 20 that the product is to be listed on a commerce server 30 (i.e., the EBAY server 30). The item server device 12 retrieves the item listing information 14 from the database 22 and utilizes HTML to tag the item listing information 14 so that the resulting tem listing notification 29 is formatted for the commerce server 30.

In response to receiving the item listing notification 29, a user of a receiver device 11 can access the dynamic item listing 27 stored by the server device 12. Based upon the access, the user can decide to purchase or make an offer to purchase the item, such as the softball, associated with the dynamic item listing 27.

As described above, the listing notification system 5 allows a user to list a product for sale on a variety of network commerce sites from a single user device 10. The listing notification system 5 minimizes the amount of time and experience needed to successfully post an item for sale on a network commerce site or on a social media site. Further, the use of dynamic item listings (e.g., webpages) helps to build trust between a buyer and a seller since the buyer can view and obtain information regarding the item for sale.

As provided above, the server device 12 can provide item listing notifications 29 to either commerce servers 30 or social media servers 32. In one arrangement, the server device 12 is also configured to provide the item listing notifications 29 to one or more second user devices 36 identified by a contact list 24 stored by the user device 10. For example, the contact list 24 can include a variety of types of contact information, such as contact names, contact phone numbers, and contact email addresses. As described below, the server device 12 is configured to utilize information on the contact list 24 for distribution of item listing notifications 29.

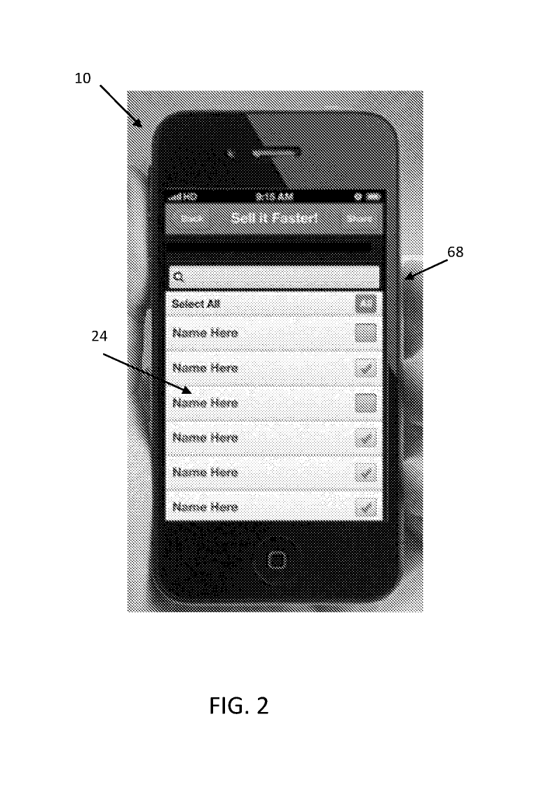

In one arrangement, as indicated in FIG. 1, when a user activates the listing application 58, the listing application is configured to access a contact list 24 stored by the controller 50 (e.g., memory) of the user device 10. Following access to the contact list, the listing application 58 is then configured to provide the contact list 24 on the display 68 to allow a user to select any number of contacts (e.g., friends, family, colleagues, etc.) from the contact list 24, as illustrated in FIG. 2. The selected contacts can be those people, considered by the user, who may be interested in receiving a notification regarding the item listing. Once the contacts are selected, the user device 10 transmits the selected contact information (e.g., the selected name and associated phone number and/or email address) as a set of contacts 34 to the server device 12.

When the server device 12 receives the set of contacts 34, in addition to the item listing information 14, the server device 12 generates a dynamic item listing 27 and an item listing notification 29, such as described above. The server device 12 is configured to then review the set of contacts 34 and forward the item listing notification 29 (e.g., a message which includes a hypertext link to the corresponding dynamic item listing 27 stored by the server device 12) to one or more second user devices 36 associated with the set of contacts 34. For example, in the case where the set of contacts 34 includes contact information for Jim, Sue, and Mary, the server device 12 transmits the item listing notification 29 associated with the devices of each of Jim, Sue, and Mary. Based upon the information included in the set of contacts, the server device 12 can forward the item listing notification 29 to the second user device as a Short Message Service (SMS) message or as an email message.

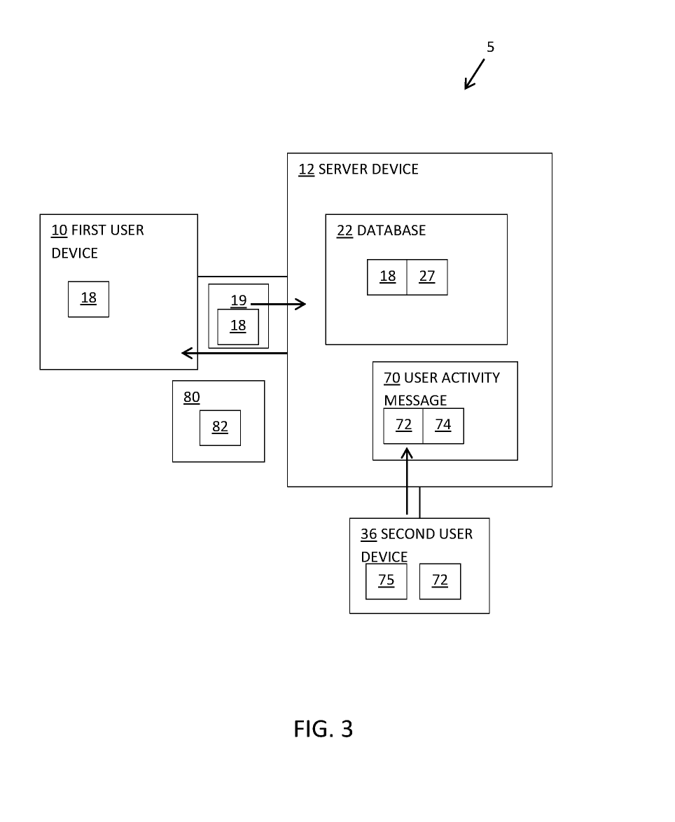

In one arrangement, the listing notification system 5 is also configured to exchange substantially real-time behavioral notifications between a first user device, such as user device 10, and a second user device, such as second user device 36 based upon user activity within the listing notification system 5. For example, with reference to FIG. 3, the server device 12 is configured to detect an activity of the second user device 36 relative to item, such as particular item listing information 14 associated with the first user device 10, and to provide the first user device 10 notification (e.g., behavioral notifications) of such activity.

For example, assume the second user device 36 views a dynamic item listing 27 of an item associated with the first user device 10 and stored on the server device 12. With such viewing, the second user device 36 generates and transmits a user activity message 70 to the server device 12. In one arrangement, the user activity message 70 includes a device identifier 72, such as an email address, phone number, or network address, which identifies the second user device 20, and a dynamic item listing identifier 74, which identifies the dynamic item listing 27 viewed by the second user device 36.

In response to receiving the user activity message 70, the server device 12 compares the dynamic item listing identifier 74 of the user activity message 70 with entries in the database 22 to find a corresponding dynamic item listing 27. In response to finding a correspondence between the dynamic item listing identifier 74 and a dynamic item listing 27, the server device 12 forwards a triggered notification message 80 to the first user device 10 which identifies the a user activity behavior 82 of the second user device 36. For example, the server device 12 provides the triggered notification message 80, such as an SMS message, a push notification, or as an email message, in substantially real-time. Such substantially real-time notification allows a first user device 10 (e.g., an application executed by the first user device 10) to know when a second user device 36 (e.g., an application executed by the second user device 36) wants to engage, such as in a commerce transaction.

The server device 12 can exchange a variety of types of triggered notification messages 80 between the first and second user devices 10, 36. In one arrangement, the triggered notification messages 80 are configured as negotiation messages associated with the negotiation of the cost of an item for a given dynamic item listing 27. With this arrangement, the server device 12 is configured to facilitate negotiation of a price of an item between user devices 10, 36.

For example, with continued reference to FIG. 3, assume a dynamic item listing 27 lists a softball for a price of $10.00 and the server device 12 provides an item notification listing 29 related to the dynamic item listing 27. Further assume that in response to viewing the dynamic item listing 27, the user of the second user device 36 decides to offer $5.00 for the softball. In such a case, the user can activate a negotiation application 75 to generate an offer message as the user activity message 70 where the offer message is associated with an offer to purchase an item identified by the dynamic item listing 27.

When the server device 12 receives the offer message 70 related to the dynamic item listing 27, the server device 12 generates a triggered offer notification as the triggered notification 80 and forwards the notification 80 to the first user device 10. As indicated above, the server device 12 provides the triggered offer notification 80, such as an in-application message, an SMS message, a push notification, or as an email message, in substantially real-time. This allows the first user device 10 to know that the second user device 36 wants to engage in a price negation for the softball.

In one arrangement, the triggered offer notification 80 includes a hyperlink that deep links the first user device 10 to the screen in the negotiation application 75 of the second user device 36. Such deep linking allows the user of the first user device 10 to view the offer provided on the second user device 36. The users of each of the user devices 10, 36 can then send substantially real-time counter offers to each other, as part of a real-time negotiation process until they agree on a price. Once a price for the softball has been agreed upon, the user of second user device 36 can then purchase the item utilizing the second user device 36.

In one arrangement, the user device 10 is configured to detect commerce behavior associated with the user and to provide commerce behavior information to the server device 12.

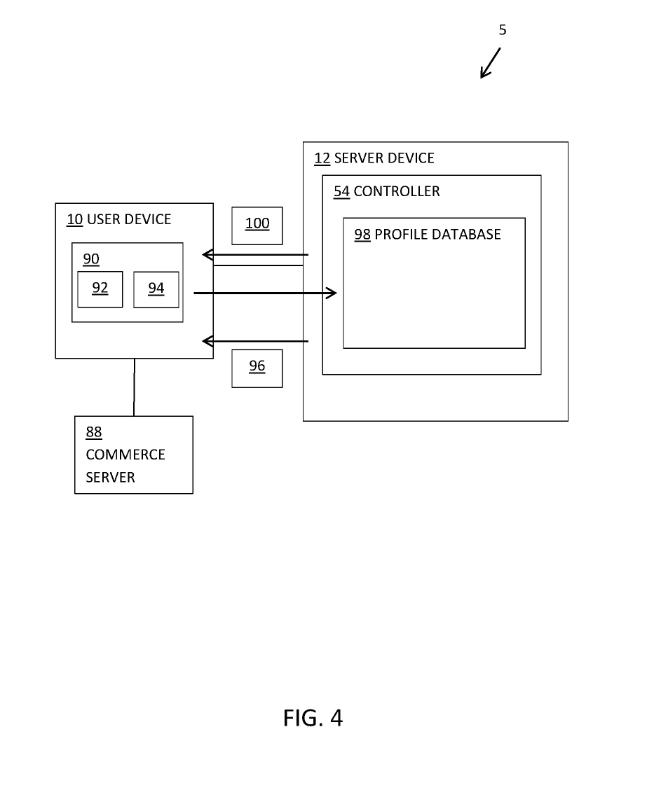

For example, with reference to FIG. 4, as the user utilizes the user device 10 to browse for products, to add products to a watch list, or to purchase products provided on one or more commerce server devices 88, the user device 10 is configured to generate a commerce behavior identifier 90 associated with the user. In one arrangement, the commerce behavior identifier 90 identifies the user device 10 and the products accessed by the user via the user device 10, as well as recency information 92 associated with the access and frequency information 94 associated with the access.

In one arrangement, the recency information 92 is configured as a score that indicates a length of time from when the user device 10 accessed particular online product and or service information on the commerce server device 88. For example, assume the user device 10 accessed an online product offering for a television on Day 1. The recency information 92 on Day 1 can be assigned a relatively high score (e.g., a score of 8 on a scale of 1 to 10) by the user device 10 to indicate that the access of the product offering was very recent. If the user device 10 does not access any additional television product offerings over the course of a week, the user device 10 can lower the value of the recency score (e.g., a score of 2 on a scale of 1 to 10). If the user device 10 continues to access product offerings for the television, the user device 10 can maintain or increase the recency score (e.g., a score of 9 on a scale of 1 to 10) to indicate that the user had most recently accessed the television product offering.

In one arrangement, the frequency information 94 is configured as a score that indicates the frequency at which the user accessed particular online product information. For example, assume the user device 10 accessed online product offerings for a television five times on Day 1, five times on Day 2, and ten times on Day 3. The frequency information 94 can be assigned a relatively high score (e.g., a score of 8 on a scale of 1 to 10) by the user device 10 to indicate that the access of the product offering was very frequent. If the user device 10 does not access any additional television product offerings over the remaining days in the week, the user device 10 can lower the value of the frequency score (e.g., a score of 2 on a scale of 1 to 10). If the user device 10 continues to access product offerings for the television for the remainder of the week, the user device 10 can maintain or increase the frequency score (e.g., a score of 9 on a scale of 1 to 10) to indicate that the user has more frequently accessed the television product offering.

The frequency information 94 can also be configured to identify the time of at which the user device 10 accesses online product information. For example, assume the user device 10 accesses the Internet on Day 1 through Day 5 between the hours of 12:00 PM and 1:00 PM. The frequency information can identify this timeframe as being a high use or frequent use timeframe associated with the user device 10.

The user device 10 provides the commerce behavior identifier 90 (e.g., the recency information 92 and/or the frequency information 94) to the server device 12 which stores the identifier 90 as an entry in a profile database 98. Over time, as the server device 12 builds the profile database 98, the server device 12 can utilize the profile database 98 to target messages, such as product or service offerings, to particular user devices 10 based upon their commerce behavior identifiers 90 (e.g., the recency information 92 and/or the frequency information 94).

For example, assume the case where an advertiser wants to identify all of the user devices 10 that accessed a telephone advertisement in the last five days in order to provide a notification 96 regarding a sale on telephones at a particular retailer. In this case, the server device 12 accesses the profile database 98 and retrieves all commerce behavior identifiers 90 associated with the access of a telephone advertisement having recency information 92 which indicate a recency of five days or less. Further based upon the frequency information 94, the server device 12 can provide a notification 96, such as a sale notification, to the user devices in an optimal manner. For example, the server device 12 can provide the sale notification 96 to the user device 10 at a particular time of day or to the user device 10 that accessed the telephone advertisement at a relatively high rate of frequency.

With the configuration of the user device 10 to detect commerce behavior associated with the user and to provide commerce behavior information to the server device 12, the user device 10 (e.g., a mobile device) is configured to execute a commerce behavior application and is not limited by relying on web cookies for tracking. This allows the server device 12 to gather a large volume of relatively high quality consumer information at a relatively granular level for a shopping recommendation engine. In one arrangement, based upon the consumer information, the server device 12 can be provide relatively efficient and precise product recommendations to the user device 10 as the user of the user device 10 accesses a network, such as the Internet, using other applications.

For example, as the user device 10 engages in commerce behavior (e.g., searching for a product, adding a product to a watch list, etc.), the user device 10 generates commerce behavior identifiers 90. These identifiers 90 which identifies the user device 10 and the products accessed by the user via the user device 10. The user device 10 transmits the commerce behavior identifiers 90 to the server device 12 in real time which stores the commerce behavior identifiers 90, as associated with the user device, in the profile database 98.

In response to reception of one or more commerce behavior identifiers 90, the server device 12 is configured to provide a selected commerce recommendation message 100, such as a product advertisement, to the user device 10. In one arrangement, the commerce recommendation message 100 can provide the user with information about products available for sale which are related to particular commerce behavior identifiers 90 generated by the behavior of the user. For example, the server device 12 forward the commerce recommendation message 100 as a teaser message in other mobile applications executed by the user device 10 to show the end user deals on items or products which the user recently searched. In one arrangement, the server device 12 can forward the commerce recommendation message 100 both within the item listing application 58 and within other applications executed by the user device 10 and/or within web sites accessed by the user device 10 based upon the commerce behavior identifiers 90 received from the user device.

With such a configuration, the server device 12 can execute re-targeting campaigns to user devices 10 for specific products that are similar to those previously searched, liked, or browsed in order to have the user engage or re-engage with the with the item listing application 58.

In one arrangement, the server device 12 is also configured to retrieve item listing information 14 from network commerce sites in order to compare the price of an item to be purchased by the second user device 36 with the prices of the same item for sale at the network commerce sites. Based on the comparison, the user (e.g., a second user device 36) can purchase the same item for less money than is being charged by the retailer.

For example, during operation, as items or products are listed on one or more commerce servers 30, the server device 12 receives the listings, which include a product description and price, and stores each listing in a database.

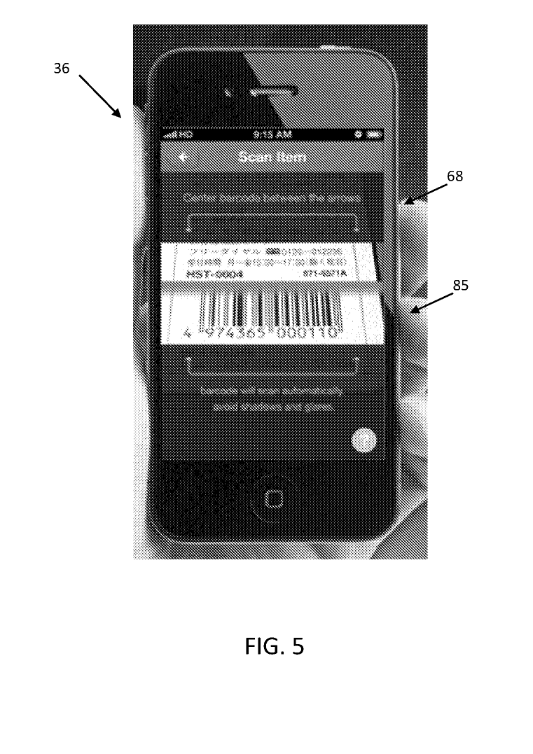

The second user device 36 is configured with a scanning application, as illustrated in FIG. 5. User scans bar code of item to be purchased in a retail store and sends the bar code information to the server device 12. In one arrangement, the bar code information includes a product description and price. In response, the item selection server 12 is configured to extract the product description and price from the bar code information and to review the database for products having matching product descriptions.

In the case where the server device 12 identifies a match between the product description provided in the database with the product description from the bar code information, the server device 12 provides a response notification to the user device 10. The response notification can include a description of the product, the price of the product, a link to the product listing on the corresponding commerce server 30, and the contact information of the seller. Upon receiving the response notification, the user device 36 can display the prices of the item. The user can then determine whether or not to purchase the item from the commerce server 30.

The scanning application as executed by the user device 36 saves the user money by allowing the user to scan the item he wants to buy at a retail store and identifying that same item in a network commerce site or social media site for a lower cost.

While various embodiments of the innovation have been particularly shown and described, it will be understood by those skilled in the art that various changes in form and details may be made therein without departing from the spirit and scope of the innovation.

What is claimed is:

1. In a server device, a method for distributing a notification regarding an item listing, comprising:
receiving from a first user device, by the server device, item listing information associated with an item and listing distribution information;
generating, by the server device, a dynamic item listing based upon the received item listing information; and
forwarding, by the server device, an item listing notification associated with the dynamic item listing to a second user device identified by the listing distribution information.

2. The method of claim 1, wherein generating the dynamic item listing based upon the received item listing information, comprises:
receiving, by the server device, an item image, an item description, and an item cost as the item listing information; and
generating, by the server device, the dynamic item listing that includes the item image, the item description, and the item cost.

3. The method of claim 1, wherein:
receiving the listing distribution information further comprises receiving from the first user device, by the server device, a set of contacts associated with the first user device; and
forwarding the item listing notification associated with the dynamic item listing to the second user device comprises forwarding, by the server device the item listing notification associated with the dynamic item listing to a set of second user devices associate with the set of contacts.

4. The method of claim 1, wherein:
receiving the listing distribution information comprises receiving from the first user device, by the server device, a social media identifier; and
forwarding the item listing notification associated with the dynamic item listing to the second user device comprises forwarding, by the server device, the item listing notification associated with the dynamic item listing to a social media server associated with the social media identifier.

5. The method of claim 1, wherein:
receiving the listing distribution information comprises receiving from the first user device, by the server device, a commerce identifier; and
forwarding the item listing notification associated with the dynamic item listing to the second user device comprises forwarding, by the server device, the item listing notification associated with the dynamic item listing to a commerce server associated with the commerce identifier.

6. The method of claim 1, further comprising:
receiving, by the server device, a user activity message identifying the second user device; and
forwarding, by the server device, a triggered notification message to the first user device in response to receiving the user activity message, the triggered notification message identifying a user activity behavior of the second user device.

7. The method of claim 6, wherein:
receiving the user activity message identifying the second user device comprises receiving, by the server device, an offer message from the second user device, the offer message associated with an offer to purchase an item identified by the dynamic item listing; and
forwarding the triggered notification message to the first user device in response to receiving the user activity message comprises transmitting, by the server device, a triggered offer notification to the first user device in response to receiving the offer message, the triggered offer notification identifying an offer to purchase an item identified by the dynamic item listing by the second user device.

8. The method of claim 7, wherein transmitting the triggered offer notification to the first user device comprises transmitting, by the server device, the triggered offer notification to the first user device in substantially real time.

9. The method of claim 1, further comprising:
receiving, by the server device, a commerce behavior identifier from the user device, the commerce behavior identifier including a user device identifier and recency information which indicates a length of time from when the user device accessed particular information in a network; and
providing, by the server device, a notification to the user device based upon the user device identifier and the recency information.

10. The method of claim 1, further comprising:
receiving, by the server device, a commerce behavior identifier from the user device, the commerce behavior identifier including a user device identifier and frequency information which indicates a frequency at which the user accessed particular information in a network; and
providing, by the server device, a notification to the user device based upon the user device identifier and the frequency information.

11. A server device configured to distribute a notification regarding an item listing, comprising:
a controller having a memory and a processor, the controller of the server device configured to:
receive from a first user device item listing information associated with an item and listing distribution information;
generate a dynamic item listing based upon the received item listing information; and
forward an item listing notification associated with the dynamic item listing to a second user device identified by the listing distribution information.

12. The server device of claim 11, wherein when generating the dynamic item listing based upon the received item listing information, the server device is configured to:
receive an item image, an item description, and an item cost as the item listing information; and
generate the dynamic item listing that includes the item image, the item description, and the item cost.

13. The server device of claim 11, wherein:
when receiving the listing distribution information, the server device is configured to receive from the first user device a set of contacts associated with the first user device; and
when forwarding the item listing notification associated with the dynamic item listing to the second user device, the server device is configured to forward the item listing notification associated with the dynamic item listing to a set of second user devices associate with the set of contacts.

14. The server device of claim 11, wherein:
when receiving the listing distribution information, the server device is configured to receive from the first user device a social media identifier; and
when forwarding the item listing notification associated with the dynamic item listing to the second user device the server device is configured to forward the item listing notification associated with the dynamic item listing to a social media server associated with the social media identifier.

15. The server device of claim 11, wherein:
when receiving the listing distribution information the server device is configured to receive from the first user device a commerce identifier; and
when forwarding the item listing notification associated with the dynamic item listing to the second user device the server device is configured to forward the item listing notification associated with the dynamic item listing to a commerce server associated with the commerce identifier.

16. The server device of claim 11, wherein the server device is configured to:
receive a user activity message identifying the second user device; and
forward a triggered notification message to the first user device in response to receiving the user activity message, the triggered notification message identifying a user activity behavior of the second user device.

17. The server device of claim 16, wherein:
when receiving the user activity message identifying the second user device, the server device is configured to receive an offer message from the second user device, the offer message associated with an offer to purchase an item identified by the dynamic item listing; and
when forwarding the triggered notification message to the first user device in response to receiving the user activity message, the server device is configured to transmit a triggered offer notification to the first user device in response to receiving the offer message, the triggered offer notification identifying an offer to purchase an item identified by the dynamic item listing by the second user device.

18. The server device of claim 17, wherein when transmitting the triggered offer notification to the first user device, the server device is configured to transmit the triggered offer notification to the first user device in substantially real time.

19. The server device of claim 1, wherein the server device is further configured to:
receive a commerce behavior identifier from the user device, the commerce behavior identifier including a user device identifier and recency information which indicates a length of time from when the user device accessed particular information in a network; and
provide a notification to the user device based upon the user device identifier and the recency information.

20. The server device of claim 1, wherein the server device is further configured to:
receive a commerce behavior identifier from the user device, the commerce behavior identifier including a user device identifier and frequency information which indicates a frequency at which the user accessed particular information in a network; and
provide a notification to the user device based upon the user device identifier and the frequency information.
